(19) United States
(12) Patent Application Publication
(10) Pub. No.: US 2023/0085726 A1
(43) Pub. Date: Mar. 23, 2023

(54) WIRELESS COMMUNICATION SYSTEM, WIRELESS CONTROL METHOD AND WIRELESS BASE STATION EQUIPMENT

(71) Applicant: NIPPON TELEGRAPH AND TELEPHONE CORPORATION, Tokyo (JP)

(72) Inventors: Masashi IWABUCHI, Musashino-shi, Tokyo (JP); Tomoaki OGAWA, Musashino-shi, Tokyo (JP); Tomoki MURAKAMI, Musashino-shi, Tokyo (JP)

(73) Assignee: NIPPON TELEGRAPH AND TELEPHONE CORPORATION, Tokyo (JP)

(21) Appl. No.: 17/911,483

(22) PCT Filed: Mar. 18, 2020
(86) PCT No.: PCT/JP2020/011946

§ 371 Date: Sep. 14, 2022

(51) Int. Cl. H04L 5/00; H04W 16/26

(52) U.S. Cl. CPC H04L 5/001; H04W 16/26; H04L 5/006

(57) ABSTRACT

A wireless communication system according to an embodiment includes: a wireless base station device configured to perform wireless communication of an orthogonal frequency division multiplexing (OFDM) method; a plurality of dynamic control relay devices for which a reradiation direction of incoming waves is dynamically controllable by the wireless base station device; and a wireless terminal device configured to perform wireless communication with the wireless base station device using a plurality of propagation paths that go through or do not go through the dynamic control relay devices. When the wireless communication is performed between the wireless base station device and the wireless terminal device using the plurality of propagation paths that go through the dynamic control relay devices, second OFDM subcarrier spacing is used, the second OFDM subcarrier spacing being spacing that is narrower than first OFDM subcarrier spacing that is used when the wireless communication is performed using the plurality of propagation paths that do not go through the dynamic control relay devices.

### TECHNICAL FIELD

Embodiments of the present invention relate to a wireless communication system, a wireless control method, and a wireless base station device.

### BACKGROUND ART

To realize high speed and large capacity wireless access, using a high frequency band that can ensure a broad bandwidth draws attention. For example, the 5th generation mobile communication system uses a 28 GHz band to realize high speed and large capacity wireless access, and the IEEE 802.11ad (millimeter-wave wireless LAN system), which is a wireless LAN (Local Area Network) standard, uses a 60 GHz band to realize the same.

In a high frequency band, radio waves are significantly attenuated compared to in a low frequency band, and have radio properties of being less likely to be diffracted. Therefore, a high frequency band has problems in short transmission distances and significant deterioration of the reception quality due to shielding.

In order to compensate the radio wave attenuation, beamforming is advantageous that uses a multielement antenna in a transmitter station and a receiver station. By compensating the radio wave attenuation based on a beamforming gain, it is possible to increase the transmission distance. In the beamforming, radio waves from a specific direction are strongly transmitted and received in both the transmitter station and the receiver station, and thus one high-power propagation path is mainly received by the receiver station. As a result, the number of spatial multiplexing is kept as 1 (or 2 in the case of polarized multiplexing), and it is also difficult to achieve the space diversity effect by receiving the same signal.

On the other hand, to improve the deterioration of the reception quality caused by shielding or non-line-of-sight, there is a method in which multiple transmission points are installed. For example, by installing many transmission antennas, it is possible to reduce the range of shielding or non-line-of-sight. In this configuration, it is also possible to solve the above-described problems in beamforming. However, installing many transmission antennas causes problems that the network cost increases and the installation place becomes insufficient.

In view of providing many transmission points, it is also advantageous to use reflectors, repeaters, and the like that are less expensive and have a smaller installation scale and restrictions. Conventionally, it was difficult to perform dynamic control on these devices. However, in recent years, a reflector that uses a metasurface to dynamically control a reflection direction, a repeater that can perform beamforming, and the like have been successfully developed, and thus it is possible to realize a method for achieving spatial multiplexing and a space diversity gain while using these devices to reduce a range of shielding or non-line-of-sight (NPL 1).

### Citation List

### [Non Patent Literature]

[NPL 1] Yuichiro Sugihara, Kei Sakaguchi, “Review of Cellular Network using mmWave Massive Relay MIMO”, the 2019 IEICE Society Conference, B-5-54, September 2019

### SUMMARY OF THE INVENTION

### Technical Problem

Even when, multiple reflectors or dynamic control relay devices, which serve as a repeater, that can be dynamically controlled are installed, and the plurality of dynamic control relay devices relay a signal from a transmitter station so as to perform beamforming between the transmitter station and a receiver station, it is possible to form a plurality of propagation routes, that is, propagation paths. By performing transmission and reception signal processing while recognizing the states of the propagation paths, the transmitter station and the receiver station can perform spatial multiplexing of the spatial multiplexing number of 3 or more, select a propagation path, or obtain a space diversity gain by combining and receiving all of the propagation paths.

Meanwhile, in the 5th generation mobile communication system or the millimeter-wave wireless LAN system that uses a high frequency band, an Orthogonal Frequency Division Multiplexing (OFDM) method is used. In the OFDM method, as a countermeasure for delay waves, a guard interval called a Cyclic Prefix (CP) is inserted between OFDM symbols to eliminate an OFDM inter-symbol interference caused by delay waves. With respect to the length of a CP, a suitable CP length is defined based on the system standard or the like, taking into consideration a scenario conceivable by the system and property deterioration caused by overhead due to CP insertion. For example, in the 5th generation mobile communication system, it is conceivable to insert a CP length that is about 7% of the OFDM symbol length.

If delay waves that exceed a CP length are received, there is a problem that OFDM inter-symbol interference cannot be completely eliminated, and the communication quality will be deteriorated. When multiple propagation paths are to be formed by the above-described dynamic control relay devices, it is conceivable that propagation paths that have a larger propagation delay than in a normal case may be generated. For example, a propagation path going through a plurality of dynamic control relay devices has a larger inter-path delay than a direct path between the transmitter station and a receiver station. Also, if repeaters are used as the dynamic control relay devices, processing delays caused by amplification processing within the repeaters will be added. When a plurality of propagation paths are combined and received, there is a high likelihood that a delay propagation path that exceeds the CP length is included, and delay waves having relatively large electric power may be received due to phase control based on a metasurface, and amplification processing and beamforming control of the repeaters.

Specifically, in a high frequency band defined in the 5th generation mobile communication system, a signal with a widened OFDM subcarrier spacing is used, taking into consideration an influence of phase noise and the like. On the assumption that the OFDM signal bandwidth is constant, when the OFDM subcarrier spacing is widened (that is to say, the number of OFDM subcarriers is reduced), the OFDM subcarrier width is increased, and a primary modulation signal can be transmitted in a broader frequency band. Thus, the symbol length of an OFDM subcarrier signal is reduced. Because an OFDM signal is a signal obtained by superimposing OFDM subcarrier signals, if the symbol lengths of the OFDM subcarrier signals are reduced, the OFDM symbol length will also be reduced consequently. Accordingly, the OFDM symbol length is reduced in proportion with the OFDM subcarrier spacing. In the 5th generation mobile communication system, the ratio of the CP length to the OFDM symbol length is basically set to be constant for all OFDM subcarrier spacing options, taking into consideration the overhead due to the CP length. Therefore, if multiple propagation paths are generated by dynamic control relay devices in a high frequency band, this may rather deteriorate the properties of the entire system due to the influence of delay waves that exceed the CP length.

Note that there is also a case where an extended CP length, which is greater than a normal CP length, is defined taking into consideration long delay waves. Using an extended CP length can solve the above-described problems, but in view of the overhead, it is not preferable to always use the extended CP length.

It is also conceivable that delay waves may differently affect users. In such a case, it is necessary to control the CP length for each user.

The present invention aims to provide, in a wireless communication system that performs transmission and reception using multiple propagation paths that are generated using a plurality of dynamic control relay devices, a technique for preventing occurrence of OFDM inter-symbol interference and reducing a deterioration in the wireless communication quality without reducing the efficiency of the entire system, even if delay waves differently affect users.

### Means for Solving the Problem

In order to solve the above-described problems, a wireless communication system according to one aspect of the present invention includes: a wireless base station device configured to perform wireless communication of an orthogonal frequency division multiplexing (OFDM) method: a plurality of dynamic control relay devices for which a reradiation direction of incoming waves is dynamically controllable by the wireless base station device; and a wireless terminal device configured to perform wireless communication with the wireless base station device using a plurality of propagation paths that go through or do not go through the dynamic control relay devices, wherein when the wireless communication is performed between the wireless base station device and the wireless terminal device using the plurality of propagation paths that go through the dynamic control relay devices, second OFDM subcarrier spacing is used, the second OFDM subcarrier spacing being spacing that is narrower than first OFDM subcarrier spacing that is used when the wireless communication is performed using the plurality of propagation paths that do not go through the dynamic control relay devices.

### Effects of the Invention

According to one aspect of the present invention, in a wireless communication system that performs transmission and reception using a plurality of propagation paths that uses or do not use a plurality of dynamic control relay devices, narrower OFDM subcarrier spacing is used when the plurality of dynamic control relay devices are used than when the plurality of dynamic control relay devices are not used, and thus it is possible to prevent occurrence of OFDM inter-symbol interference and reduce a deterioration in the wireless communication quality without reducing the efficiency of the entire system, even if delay waves differently affect users.

### BRIEF DESCRIPTION OF DRAWINGS

FIG. 1 is a schematic diagram illustrating an example of a configuration of a wireless communication system according to a first embodiment of the present invention.

FIG. 2 is a block diagram illustrating an example of a hardware configuration of a wireless base station device according to the first embodiment.

FIG. 3 is a schematic diagram illustrating an example of a configuration of a computer that functions as the wireless base station device according to the first embodiment.

FIG. 4 is a block diagram illustrating an example of a wireless transmission-related hardware configuration of a wireless terminal device of the first embodiment.

FIG. 5 is a flowchart illustrating an example of an OFDM subcarrier spacing determination processing operation performed by a subcarrier spacing selection unit of the wireless base station device according to the first embodiment.

FIG. 6 is a flowchart illustrating an example of an OFDM subcarrier spacing determination processing operation performed by the subcarrier spacing selection unit of the wireless base station device according to a second embodiment of the present invention.

FIG. 7 is a flowchart illustrating an example of an OFDM subcarrier spacing determination processing operation performed by the subcarrier spacing selection unit of the wireless base station device according to a third embodiment of the present invention.

FIG. 8 is a flowchart illustrating an example of an OFDM subcarrier spacing determination processing operation performed by the subcarrier spacing selection unit of the wireless base station device according to a fourth embodiment of the present invention.

FIG. 9 is a flowchart illustrating an example of an OFDM subcarrier spacing determination processing operation performed by the subcarrier spacing selection unit of the wireless base station device according to a fifth embodiment of the present invention.

FIG. 10 is a flowchart illustrating an example of an OFDM subcarrier spacing determination processing operation performed by the subcarrier spacing selection unit of the wireless base station device according to a sixth embodiment of the present invention.

### DESCRIPTION OF EMBODIMENTS

Hereinafter, embodiments of the present invention will be described with reference to the drawings.

### First Embodiment

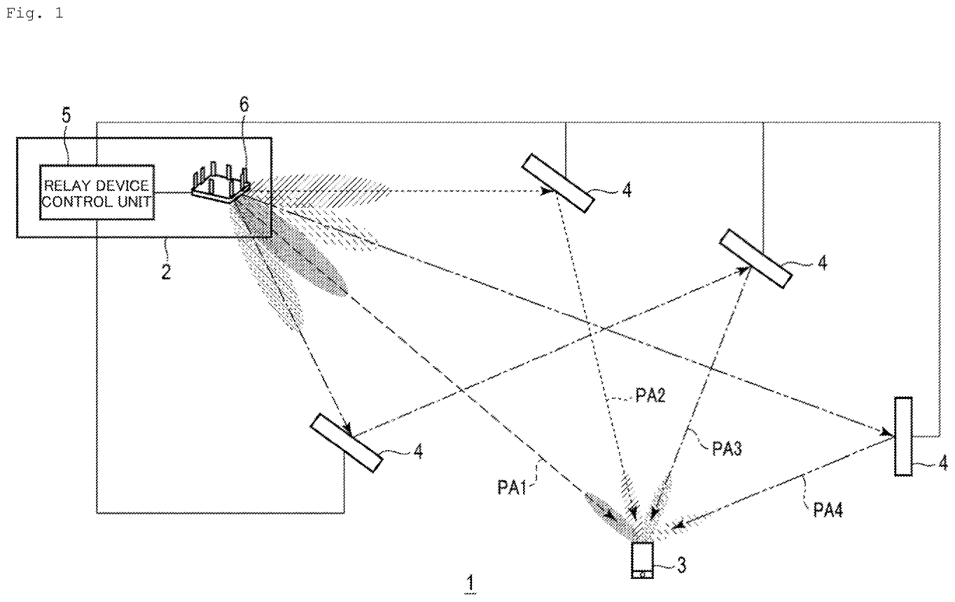

FIG. 1 is a schematic diagram illustrating an example of a configuration of a wireless communication system 1 according to a first embodiment of the present invention. As the wireless communication system 1 shown in FIG. 1, an example is described in which a wireless base station device 2 is a transmitter station, and a wireless terminal device 3 is a receiver station. There is also a case where after the start of communication, the relationship of the transmitter station and the receiver station is inverted, that is, the wireless base station device 2 is a receiver station, and the wireless terminal device 3 is a transmitter station.

In the wireless communication system 1 shown in FIG. 1, dynamic control relay devices 4 are installed within wireless channels between the transmitter station and the receiver station. The number of installed dynamic control relay devices 4 can be suitably set. Each of the dynamic control relay devices 4 is a reflector or a repeater, for example. These dynamic control relay devices 4 can reradiate incoming waves in any direction by mechanically moving or rotating, or electrically controlling their phases or amplitudes. FIG. 1 shows an example in which a propagation path PA1 leading from the wireless base station device 2 to the wireless terminal device 3 without the intermediary of any dynamic control relay device 4, and three propagation paths PA2, PA3, and PA4 that go through any dynamic control relay device 4 are generated. There may be a case where a propagation path, like the propagation path PA3, is generated using a plurality of dynamic control relay devices 4.

The wireless base station device 2 includes a relay device control unit 5 and a wireless communicator 6. Each of the dynamic control relay devices 4 is connected to the relay device control unit 5 of the wireless base station device 2 by wired communication or wireless communication, so that the reradiation direction is controlled. The relay device control unit 5 has functions of determining information relating to at least one of the dynamic control relay devices 4 that is to be used in wireless transmission and to the reradiation direction thereof, and notifying the dynamic control relay device 4 of the information. The relay device control unit 5 also has a function of collecting the state of the dynamic control relay device 4, and information available by the dynamic control relay device 4. Here, information available by the dynamic control relay device 4 means, for example, information obtained by a dynamic control relay device 4 having a sensing function, using its sensing function. Examples of the information obtained using the sensing function include position information obtained by a GPS (Global Positioning System) sensor or the like, and an installation angle of the dynamic control relay device 4 obtained by a gyrosensor or the like.

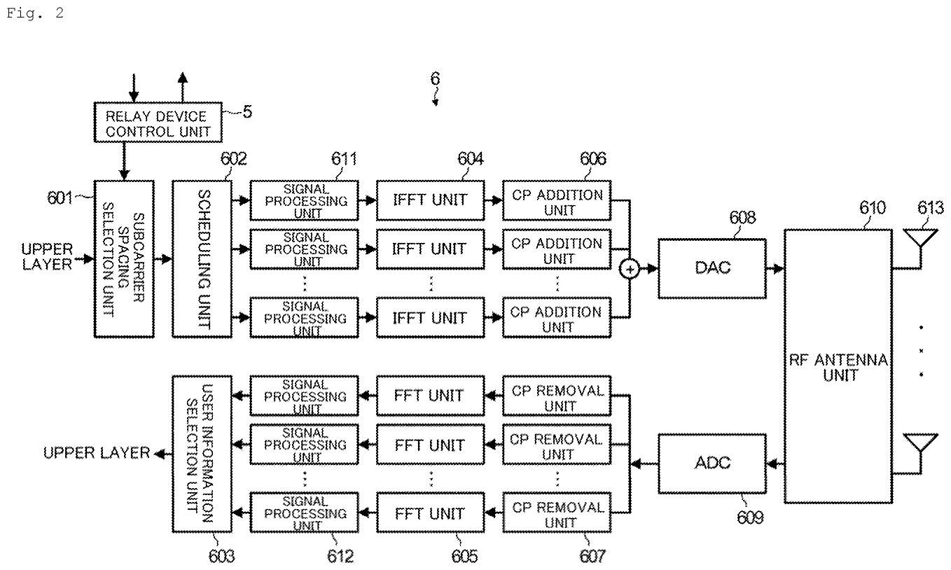

FIG. 2 is a block diagram illustrating an example of a hardware configuration of the wireless base station device 2 according to the first embodiment. As described above, the wireless base station device 2 includes the relay device control unit 5 and the wireless communicator 6.

As described above, the relay device control unit 5 determines information relating to at least one dynamic control relay device 4 to be used in wireless transmission and to a reradiation direction thereof, notifies the dynamic control relay device 4 of the information, and collects the state of the dynamic control relay device 4 and information available by the dynamic control relay device 4. The determination operation, the notification operation, and the collection operation of the relay device control unit 5 may be performed at any timing (or any time span).

For example, when the reflection/reradiation direction of a dynamic control relay device 4 is to be oriented to the wireless terminal device 3 in a pinpoint manner, the relay device control unit 5 determines information relating to at least one dynamic control relay device 4 to be used in wireless transmission and a reradiation direction, at a timing at which the wireless base station device 2 performs beam control. As a specific example, when beam searching is executed using a synchronization signal, the timing at which the above-described determination is performed matches a timing at which after transmission of the synchronization signal, the searching is complete for combinations of all beams and all reflection/reradiation directions. At this time, the relay device control unit 5 determines information relating to at least one dynamic control relay device 4 to be used in wireless transmission and a reradiation direction, so that the beams, the dynamic control relay device 4, and the reflection/reradiation direction that have the best reception quality are selected. Also, the relay device control unit 5 may transmit a synchronization signal to only search all beams. At this time, the relay device control unit 5 determines at least one dynamic control relay device 4 and a reflection/reradiation direction using, for example, a positioning result of the wireless terminal device 3, and determines beams by beam searching. The positioning result may be obtained by positioning performed by the wireless base station device 2, or may be obtained by feeding back a result of positioning performed by the wireless terminal device 3. There is no particular regulation for the positioning method.

Also, the reflection/reradiation direction may be controlled so as to be oriented to the wireless terminal device 3, or may be oriented to an area in which the wireless terminal device 3 is present. If, for example, a metamaterial reflector is used as a dynamic control relay device 4, radio waves can be reflected in various directions, and if a repeater capable of performing beamforming is used as a dynamic control relay device 4, it is possible to perform beam control and reradiate radio waves in a wide beam width. In this case, the reflection/reradiation direction of the dynamic control relay device 4 is not necessarily controlled according to the movement of the wireless terminal device 3, and thus the relay device control unit 5 may suitably determine the above-described information relating to at least one dynamic control relay device 4 to be used in wireless transmission and a reradiation direction, within a range from several milliseconds to several seconds, or may determine the above-described information in units of day. At this time, the information on which the determination of the relay device control unit 5 is based may be the positioning result of the wireless terminal device 3 as described above, or may be a distribution of the wireless terminal device 3 obtained by previous positioning results. Alternatively, as the basis of the determination, the relay device control unit 5 may use a result obtained by capturing an image of the actual place using a camera and analyzing the image, may use radio wave propagation information obtained by simulation, or may be use statistical information relating to reception power, communication quality, and traffic obtained when the wireless base station device 2 communicates with the wireless terminal device 3.

Also, on the assumption that information on the arrangement of the dynamic control relay devices 4 is known, if beams and reflection/reradiation directions are determined, it is possible to estimate routes through which radio waves come from the wireless base station device 2 to the wireless terminal device 3. Accordingly, based on this result, the relay device control unit 5 can determine at least one dynamic control relay device 4 to be used.

As shown in FIG. 2, the wireless communicator 6 includes a subcarrier spacing selection unit 601, a scheduling unit 602, a user information selection unit 603, Inverse Fast Fourier Transform (IFFT) units 604, Fast Fourier Transform (FFT) units 605, CP addition units 606, CP removal units 607, a Digital to Analog Converter (DAC) 608, an Analog to Digital Converter (ADC) 609, a RF (Radio Frequency) antenna unit 610, and signal processing units 611 and 612. The numbers of the IFFT unit 604, the FFT unit 605, the CP addition unit 606, the CP removal unit 607, and the signal processing units 611 and 612 correspond to the number of associated OFDM subcarrier spacing. Alternatively, a configuration is also possible in which an IFFT unit 604 and a FFT unit 605 that can execute FFT (IFFT) processing in a switched manner at FFT (IFFT) points that correspond to the number of OFDM subcarriers of transmission signals are used, and a single CP addition unit 606, a single CP removal unit 607, a signal processing unit 611, and a signal processing unit 612 are used.

The subcarrier spacing selection unit 601 determines OFDM subcarrier spacing of signals to be transmitted to users, based on the information relating to dynamic control relay devices 4 to be used in wireless transmission that was determined by the relay device control unit 5. Also, to notify the wireless terminal device 3 of the determined OFDM subcarrier spacing, the subcarrier spacing selection unit 601 causes the signal processing units 611, the IFFT units 604, and the CP addition units 606 to process the information relating to the determined OFDM subcarrier spacing into a wireless signal, and gives the notification to the target wireless terminal device 3 via the RF antenna unit 610. This notification may be made using a control channel of the wireless communication system 1 or another channel. A specific method for determining OFDM subcarrier spacing will be described later.

To perform signal processing based on the OFDM subcarrier spacing determined by the subcarrier spacing selection unit 601, the scheduling unit 602 sorts information relating to the users given from an upper layer, and outputs the sorted information to the signal processing units 611 that generate signals of the corresponding OFDM subcarrier spacing.

The user information selection unit 603 outputs signals demodulated via the signal processing units 612 as signals for each user to an upper layer.

Each IFFT unit 604 performs IFFT processing on a wireless signal generated by the corresponding signal processing unit 611, and outputs the IFFT-processed wireless signal to the corresponding CP addition unit 606.

Each FFT unit 605 performs FFT processing on a wireless signal output from the corresponding CP removal unit 607, and outputs the FFT-processed wireless signal to the corresponding signal processing unit 612.

Each CP addition unit 606 adds a CP to the wireless signal output from the corresponding IFFT unit 604, and outputs the wireless signal to which the CP was added to the DAC 608. Note that a filtering unit may be provided on the downstream of the CP addition unit 606.

Each CP removal unit 607 removes a CP from a wireless signal received via the RF antenna unit 610 and the ADC 609, and outputs the wireless signal from which the CP was removed to the corresponding FFT unit 605. Note that a filtering unit may be provided on the upstream of the CP removal unit 607.

The DAC 608 converts digital wireless signals processed by the CP addition units 606 into analog signals, and outputs the analog signals to the RF antenna unit 610.

The ADC 609 converts analog wireless signals received via the RF antenna unit 610 into digital signals, and outputs the digital signals to the CP removal units 607.

The RF antenna unit 610 up-converts, as transmission processing, a wireless signal into a signal of a system band frequency. Then, the RF antenna unit 610 radiates the wireless signal whose power was amplified by a power amplifier via the antenna 613. Also, in the reception processing of the RF antenna unit 610, a wireless signal received by the antenna 613 is amplified by a low noise amplifier, and then is down-converted. The RF antenna unit 610 may also include a plurality of RF units, and a plurality of antennas 613. In the transmission and reception processing of the RF antenna unit 610, a variable phase shifter and a variable gain controller may be used to perform analog beamforming.

Each signal processing unit 611 performs processing for generating a wireless signal to be transmitted, and each signal processing unit 612 performs processing for decoding a received wireless signal. The signal processing units 611 and 612 generate and decode all the signals required in the corresponding wireless communication system 1. Also, each signal processing unit 611 generates, based on information relating to OFDM subcarrier spacing determined by the subcarrier spacing selection unit 601, a wireless signal to be used to notify the wireless terminal device 3 of this information relating to OFDM subcarrier spacing.

At least portions of the relay device control unit 5 and the wireless communicator 6 that constitute the wireless base station device 2 can be realized by IC circuits such as ASICs (Application Specific Integrated Circuits) or FPGAs (Field Programmable Gate Arrays). For example, the relay device control unit 5 may be formed of one ASIC, and the subcarrier spacing selection unit 601, the scheduling unit 602, the user information selection unit 603, the IFFT units 604, the FFT units 605, the CP addition units 606, the CP removal units 607, and the signal processing units 611 and 612 may be formed of one ASIC. The DAC 608 and the ADC 609 that are formed of one IC chip, and the RF antenna unit 610 that is formed of one IC chip are also commercially available. Also, portions of the relay device control unit 5 and the wireless communicator 6 that process digital signals may be replaced by a DSP (Digital Signal Processor), and this function may be realized by software provided inside the DSP, or by a computer and a program.

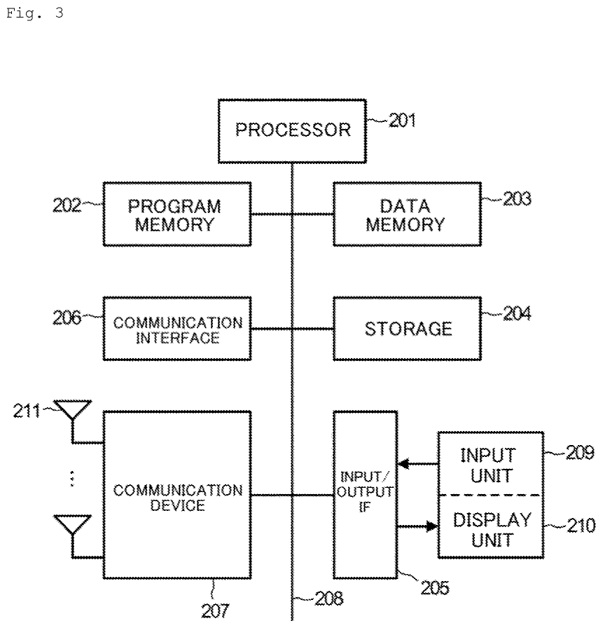

FIG. 3 is a schematic diagram illustrating an example of a configuration of a computer that functions as the wireless base station device 2. As shown in FIG. 2, the wireless base station device 2 is constituted by a computer device, and includes a processor 201 such as a CPU. Also, in the wireless base station device 2, a program memory 202, a data memory 203, a storage 204, an input/output interface (denoted as an input/output IF in FIG. 3) 205, a communication interface 206, and a communication device 207 are connected to the processor 201 via a bus 208.

The program memory 202 serves as a non-transitory and tangible computer-readable storage medium, and is realized by a combination of a freely writable and readable nonvolatile memory such as a flash memory, and a nonvolatile memory such as a ROM (Read Only Memory). In this program memory 202, programs are stored that are required for the processor 201 to execute various types of control processing.

The data memory 203 serves as a tangible computer-readable storage medium, and is realized by a combination of the above-described nonvolatile memory and a volatile memory such as a RAM (Random Access Memory). This data memory 203 is used to store various types of data acquired and generated during the execution of various types of processing.

The storage 204 serves as a non-transitory and tangible computer-readable storage medium, and includes a large-capacity storage medium that uses a freely writable and readable nonvolatile memory such as HDD (Hard Disk Drive) or SSD (Solid State Drive), for example. In this storage 204, various types of programs and data are stored that are required for the processor 201 to execute various types of control processing. For example, a communication control program is stored that is required for the processor 201 serving as the wireless base station device 2 according to the first embodiment to execute control processing. The programs stored in the storage 204 are read into the data memory 203 and are executed by the processor 201 as needed. The communication control program can cause, for example, the processor 201 to function as the relay device control unit 5, the subcarrier spacing selection unit 601, the scheduling unit 602, the user information selection unit 603, the IFFT unit 604, the FFT unit 605, the CP addition unit 606, the CP removal unit 607, and the signal processing units 611 and 612 that are shown in FIG. 2. Note that the communication control program may also be stored in the program memory 202, instead of the storage 204.

An input unit 209 and a display unit 210 are connected to the input/output interface 205. The input unit 209 and the display unit 210 may employ a so-called tablet-type input/display device in which a capacitive-type or pressure-type input detection sheet is arranged on a display screen of a liquid crystal or electro luminescence display device, for example. Also, the input unit 209 and the display unit 210 may also be constituted by independent devices. The input/output interface 205 inputs operation information input from the above-described input unit 209 to the processor 201, and causes the display unit 210 to display information for display generated by the processor 201. Note that the computer serving as the wireless base station device 2 does not necessarily include the input/output interface 205, the input unit 209, and the display unit 210. The operation information given to the processor 201 and the information for display given from the processor 201 are transmitted and received by the communication interface 206 via a not-shown network, and can be input from an input device connected to the network or can be displayed on the display device.

The communication interface 206 can include at least one wired or wireless communication module, for example. The communication interface 206 receives data addressed to a user of the wireless terminal device 3 or transmits data from a user to the destination thereof, via a not-shown network.

The communication device 207 can include the DAC 608, the ADC 609, and the RF antenna unit 610 that are shown in FIG. 2. The communication device 207 may also serve as the RF antenna unit 610, and the DAC 608 and the ADC 609 may also be arranged between the communication device 207 and the bus 208. An antenna 211, which is the antenna 613 shown in FIG. 2, is connected to the communication device 207.

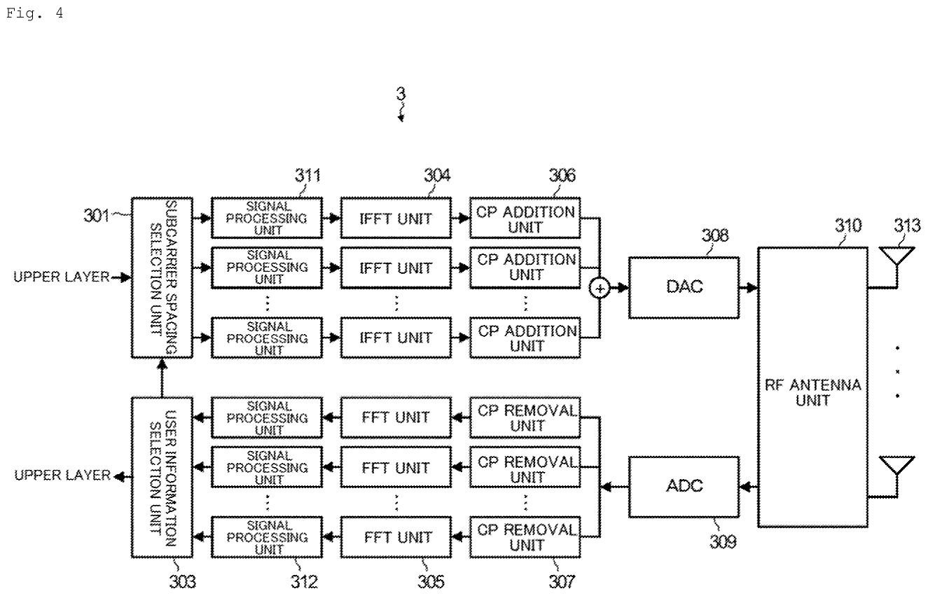

FIG. 4 is a block diagram illustrating an example of a wireless transmission-related hardware configuration of the wireless terminal device 3. As shown in FIG. 4, the wireless terminal device 3 includes a subcarrier spacing selection unit 301, a user information selection unit 303, IFFT units 304, FFT units 305, CP addition units 306, CP removal units 307, a DAC 308, an ADC 309, a RF antenna unit 310, and signal processing units 311 and 312.

The subcarrier spacing selection unit 301 determines OFDM subcarrier spacing of signals to be transmitted by the wireless terminal device 3, based on the information relating to OFDM subcarrier spacing that was given from the wireless base station device 2 and was obtained through processing of the user information selection unit 303 of the wireless terminal device 3.

The user information selection unit 303 outputs signals demodulated via the signal processing units 312 as signals for each user to an upper layer. Also, the user information selection unit 303 notifies the subcarrier spacing selection unit 301 of the information relating to OFDM subcarrier spacing given from the wireless base station device 2.

Each IFFT unit 304 performs IFFT processing on a wireless signal generated by the corresponding signal processing unit 311, and outputs the IFFT-processed wireless signal to the corresponding CP addition unit 306.

Each FFT unit 305 performs FFT processing on a wireless signal output from the corresponding CP removal unit 307, and outputs the FFT-processed wireless signal to the corresponding signal processing unit 312.

Each CP addition unit 306 adds a CP to the wireless signal output from the corresponding IFFT unit 304, and outputs the wireless signal to which the CP was added to the DAC 308. Note that a filtering unit may be provided on the downstream of the CP addition unit 306.

Each CP removal unit 307 removes a CP from a wireless signal received via the RF antenna unit 310 and the ADC 309, and outputs the wireless signal from which the CP was removed to the corresponding FFT unit 305. Note that a filtering unit may be provided on the upstream of the CP removal unit 307.

The DAC 308 converts digital wireless signals processed by the CP addition units 306 into analog signals, and outputs the analog signals to the RF antenna unit 310.

The ADC 309 converts analog wireless signals received via the RF antenna unit 310 into digital signals, and outputs the digital signals to the CP removal units 307.

The RF antenna unit 310 up-converts, as transmission processing, a wireless signal into a signal of a system band frequency. Then, the RF antenna unit 310 radiates the wireless signal whose power was amplified by a power amplifier via the antenna 313. Also, in the reception processing of the RF antenna unit 310, a wireless signal received by the antenna 313 is amplified by a low noise amplifier, and then is down-converted. The RF antenna unit 310 may also include a plurality of RF units, and a plurality of antennas 313. In the transmission and reception processing of the RF antenna unit 310, a variable phase shifter and a variable gain controller may be used to perform analog beamforming.

Each signal processing unit 311 performs processing for generating a wireless signal to be transmitted, and each signal processing unit 312 performs processing for decoding a received wireless signal. The signal processing units 311 and 312 generate and decode all the signals required in the corresponding wireless communication system 1.

At least portions of the wireless transmission-related hardware configuration of the wireless terminal device 3 can be realized by IC circuits such as ASICs or FPGAs. For example, the subcarrier spacing selection unit 301, the user information selection unit 303, the IFFT units 304, the FFT units 305, the CP addition units 306, the CP removal units 307, and the signal processing units 311 and 312 may be formed of one ASIC. The DAC 308 and the ADC 309 that are formed of one IC chip, and the RF antenna unit 310 that is formed of one IC chip are also commercially available. Also, a digital single processing portion of the hardware configurations that is associated with wireless transmission may be replaced by a DSP, and this function may be realized by software provided inside the DSP, or by a computer and a program.

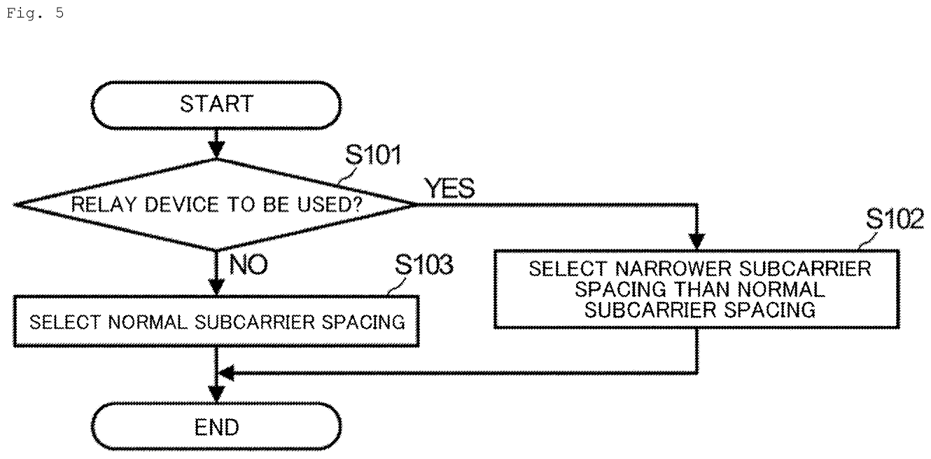

FIG. 5 is a flowchart illustrating an example of an OFDM subcarrier spacing determination processing operation performed by the subcarrier spacing selection unit 601 of the wireless base station device 2 according to the first embodiment. The subcarrier spacing selection unit 601 executes the operation as shown in the flowchart to determine OFDM subcarrier spacing for each user, that is, each wireless terminal device 3. If the wireless base station device 2 is constituted by a computer, the processor 201 can execute the processing operation in accordance with this flowchart by executing the communication control program, and can function as the subcarrier spacing selection unit 601.

Note that the subcarrier spacing selection unit 601 may operate at any timing (or any time span). For example, when a dynamic control relay device 4 to be passed through is determined, a delay can be estimated to some extent, and subcarrier spacing can be determined, and thus the operation shown in the flowchart may be executed at a timing at which a dynamic control relay device 4 is determined by the relay device control unit 5.

The subcarrier spacing selection unit 601 determines whether or not the relay device control unit 5 has given a notification of determination to perform wireless transmission from the wireless base station device 2 to the wireless terminal device 3 of a target user using any dynamic control relay device 4 (step S101). The notification given from the relay device control unit 5 may be a notification indicating whether or not any dynamic control relay device 4 is to be used.

If it is determined that the relay device control unit 5 has given a notification (YES, in step S101), the subcarrier spacing selection unit 601 determines, as OFDM subcarrier spacing to be used, narrower OFDM subcarrier spacing than normally used OFDM subcarrier spacing (step S102).

In contrast, if it is determined that the relay device control unit 5 has not given a notification of determination to perform wireless transmission from the wireless base station device 2 to the wireless terminal device 3 using any dynamic control relay device 4 (NO, in step S101), the subcarrier spacing selection unit 601 determines normal OFDM subcarrier spacing as the OFDM subcarrier spacing to be used (step S103).

With this operation, it is possible to reduce the influence of delay waves caused by using the dynamic control relay devices 4 in this wireless communication system 1.

Note that an OFDM subcarrier spacing determination processing operation performed by the subcarrier spacing selection unit 301 of the wireless terminal device 3 is the same as this operation, except that the determination as to whether or not any dynamic control relay device 4 is to be used is made based on a notification from the user information selection unit 303, instead of a notification from the relay device control unit 5.

As described above, in the first embodiment, the wireless communication system 1 is provided that includes the wireless base station device 2 and the plurality of dynamic control relay devices 4, which are relay devices for which a reradiation direction of incoming waves is dynamically controllable, and in which the wireless base station device 2 performs wireless communication of an OFDM method with a wireless terminal device 3 using a plurality of propagation paths via the dynamic control relay devices 4. In the wireless communication system 1, the subcarrier spacing selection unit 601 changes OFDM subcarrier spacing based on whether or not any dynamic control relay device 4 is used. That is to say, if wireless communication is to be performed using the plurality of propagation paths via the dynamic control relay devices 4, the subcarrier spacing selection unit 601 determines to use narrower OFDM subcarrier spacing than normal OFDM subcarrier spacing that is used when the wireless communication is performed using a plurality of propagation paths that do not go through any dynamic control relay device 4. Accordingly, even if delay waves differently affect users, it is possible to prevent occurrence of OFDM inter-symbol interference and reduce a deterioration in the wireless communication quality, without reducing the efficiency of the entire system. That is to say, by performing control of the propagation paths and control of OFDM subcarrier spacing in a cooperated manner, it is possible to prevent occurrence of OFDM inter-symbol interference and reduce a deterioration in the wireless communication quality. Furthermore, if delay waves differently affect users, signals with different OFDM subcarrier spacing for users can be accommodated in the same frequency band.

In the first embodiment, OFDM subcarrier spacing is selected based on whether or not any dynamic control relay device 4 is used, but may also be selected by cooperation with another type of control of the dynamic control relay devices 4.

The following will describe, as second to sixth embodiments, examples in which based on whether or not any dynamic control relay device 4 is used, OFDM subcarrier spacing is selected for each user, and a plurality of users with different propagation routes, that is, propagation paths are multiplexed in a frequency range.

### Second Embodiment

The wireless communication system 1 according to a second embodiment differs from the first embodiment in the OFDM subcarrier spacing determination processing operation performed by the subcarrier spacing selection unit 601 of the wireless base station device 2, and other configurations and operations are the same as those in the first embodiment. Therefore, only the difference from the first embodiment is described, and descriptions of the other features are omitted.

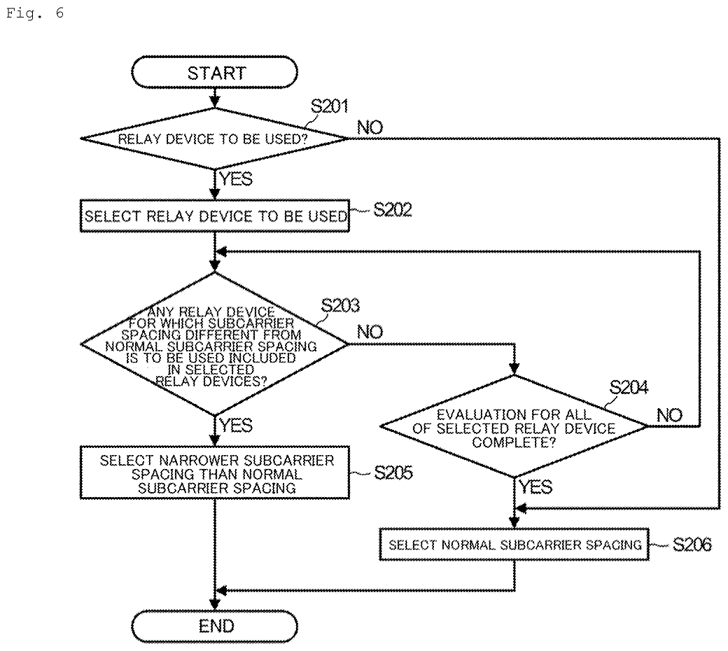

FIG. 6 is a flowchart illustrating an example of an OFDM subcarrier spacing determination processing operation performed by the subcarrier spacing selection unit 601 of the second embodiment. The subcarrier spacing selection unit 601 executes the operation as shown in this flowchart to determine OFDM subcarrier spacing for each user, that is, each wireless terminal device 3. If the wireless base station device 2 is constituted by a computer, the processor 201 can execute the processing operation in accordance with this flowchart by executing the communication control program, and can function as the subcarrier spacing selection unit 601.

The subcarrier spacing selection unit 601 determines whether or not the relay device control unit 5 has given a notification of determination to perform wireless communication from the wireless base station device 2 to the wireless terminal device 3 of a target user using any dynamic control relay device 4 (step S201). The notification given from the relay device control unit 5 may be a notification indicating whether or not any dynamic control relay device 4 is to be used, and information relating to selected one or more dynamic control relay devices 4, that is, information indicating which dynamic control relay device 4 is to be used.

If it is determined that the relay device control unit 5 has given such a notification (YES, in step S201), the subcarrier spacing selection unit 601 selects one or more dynamic control relay devices 4 that are to be used and are included in the notification from the relay device control unit 5 (step S202).

Then, the subcarrier spacing selection unit 601 references OFDM subcarrier spacing information preliminarily allocated to all of the selected dynamic control relay devices 4, and determines whether or not there is any dynamic control relay device 4 for which narrower OFDM subcarrier spacing than normally used OFDM subcarrier spacing is to be used (step S203).

Here, if it is determined that there is no dynamic control relay device 4 for which narrower OFDM subcarrier spacing than normally used OFDM subcarrier spacing is to be used (NO, in step S203), the subcarrier spacing selection unit 601 determines whether or not evaluation is complete for all of the dynamic control relay devices 4 selected in step S202 (step S204). If there is a dynamic control relay device 4 for which evaluation is not complete (NO, in step S204), the subcarrier spacing selection unit 601 returns to the operation in step S203.

If there is any dynamic control relay device 4 for which narrower OFDM subcarrier spacing than normally used OFDM subcarrier spacing is to be used (YES, in step S203), the subcarrier spacing selection unit 601 determines, as the OFDM subcarrier spacing to be used, the narrowest OFDM subcarrier spacing of OFDM subcarrier spacing for the dynamic control relay devices 4 (step S205).

In contrast, if it is determined in step S204 that evaluation is complete for all of the selected dynamic control relay devices 4 (YES, in step S204), the subcarrier spacing selection unit 601 determines normal OFDM subcarrier spacing as the OFDM subcarrier spacing to be used (step S206). Also, if it is determined in step S201 that the relay device control unit 5 has not given a notification of determination to perform wireless communication from the wireless base station device 2 to the wireless terminal device 3 of the target user using any dynamic control relay device 4 (NO, in step S201), the subcarrier spacing selection unit 601 determines the normal OFDM subcarrier spacing as the OFDM subcarrier spacing to be used.

Note that the preliminary allocation of OFDM subcarrier spacing may be determined when the dynamic control relay devices 4 are installed, and can be stored in the subcarrier spacing selection unit 601. Alternatively, the preliminary allocation may also be stored in the relay device control unit 5, instead of the subcarrier spacing selection unit 601, and OFDM subcarrier spacing information allocated to dynamic control relay devices 4 to be used may be transmitted from the relay device control unit 5 to the subcarrier spacing selection unit 601, while being included in the above-described notification. Also, if a dynamic control relay device 4 includes a GPS sensor or a gyrosensor, the dynamic control relay device 4 may notify the relay device control unit 5 of the wireless base station device 2 of positional information obtained by the GPS sensor of the dynamic control relay device 4 or installation angle information obtained by the gyrosensor in a wired or wireless manner on a regular basis, and the relay device control unit 5 may determine an appropriate OFDM subcarrier spacing and may perform update and saving.

As described above, in the second embodiment, the subcarrier spacing selection unit 601 determines the narrowest OFDM subcarrier spacing of the OFDM subcarrier spacing preliminary allocated to the relay devices. That is to say, when wireless communication is to be performed using the plurality of propagation paths going through the dynamic control relay devices 4, the subcarrier spacing selection unit 601 determines to use OFDM subcarrier spacing that corresponds to the selected relay devices. By selecting OFDM subcarrier spacing based on communication paths in this manner, it is possible to dynamically switch to a CP length with which the influence of delay waves is reduced (so that the ratio of the CP length to the OFDM symbol length is constant, for example). Accordingly, it is possible to prevent the use of an unduly long CP length and reduce the overhead due to the CP, compared to a case where a fixed CP length is used taking into consideration delay waves.

### Third Embodiment

The wireless communication system 1 according to a third embodiment differs from the first embodiment in the OFDM subcarrier spacing determination processing operation performed by the subcarrier spacing selection unit 601 of the wireless base station device 2, and other configurations and operations are the same as those in the first embodiment. Therefore, only the difference from the first embodiment is described, and descriptions of the other features are omitted.

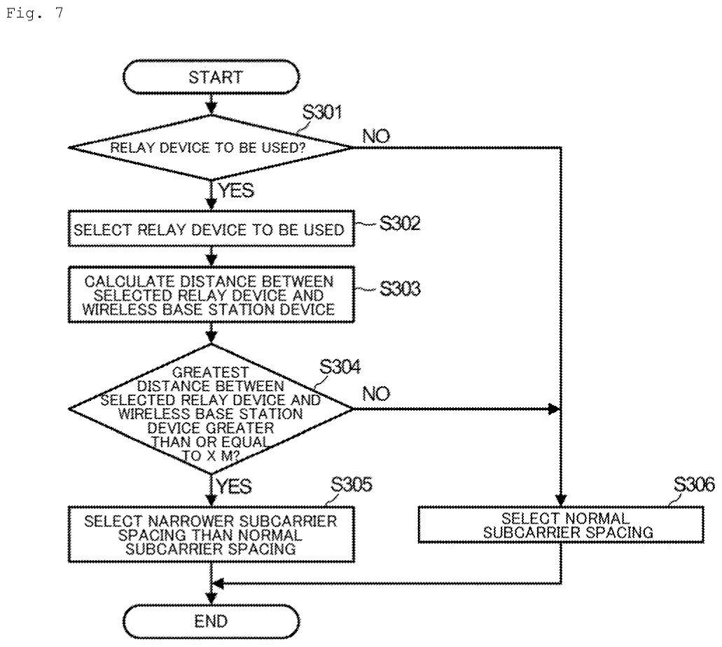

FIG. 7 is a flowchart illustrating an example of an OFDM subcarrier spacing determination processing operation performed by the subcarrier spacing selection unit 601 of the third embodiment. The subcarrier spacing selection unit 601 executes the operation as shown in the flowchart to determine OFDM subcarrier spacing for each user, that is, each wireless terminal device 3. If the wireless base station device 2 is constituted by a computer, the processor 201 can execute the processing operation in accordance with this flowchart by executing the communication control program, and can function as the subcarrier spacing selection unit 601.

The subcarrier spacing selection unit 601 determines whether or not the relay device control unit 5 has given a notification of determination to perform wireless transmission from the wireless base station device 2 to the wireless terminal device 3 of a target user using any dynamic control relay device 4 (step S301). The notification given from the relay device control unit 5 may be a notification indicating whether or not any dynamic control relay device 4 is to be used, and information relating to selected one or more dynamic control relay devices 4, that is, information indicating which dynamic control relay device 4 is to be used.

If it is determined that the relay device control unit 5 has given such a notification (YES, in step S301), the subcarrier spacing selection unit 601 selects one or more dynamic control relay devices 4 that are to be used and are included in the notification from the relay device control unit 5 (step S302).

Then, the subcarrier spacing selection unit 601 calculates distances between all of the selected dynamic control relay devices 4 and the wireless base station device 2 (step S303). Note that instead of calculating the distances, distances calculated in advance may be referenced.

Then, the subcarrier spacing selection unit 601 determines whether or not the greatest distance of the distances between the selected dynamic control relay devices 4 and the wireless base station device 2 is greater than or equal to a predetermined threshold distance X m (step S304). Here, X is any value, and may be calculated based on a propagation delay acceptable by the wireless system.

Here, if it is determined that the greatest distance is greater than or equal to the threshold distance X m (YES, in step S304), the subcarrier spacing selection unit 601 determines, as the OFDM subcarrier spacing to be used, the narrowest OFDM subcarrier spacing of the OFDM subcarrier spacing of these dynamic control relay devices 4 (step S305).

In contrast, if it is determined in step S304 that the greatest distance is not greater than or equal to the threshold distance X m (NO, in step S304), the subcarrier spacing selection unit 601 determines normal OFDM subcarrier spacing as the OFDM subcarrier spacing to be used (step S306). Also, if it is determined in step S301 that the relay device control unit 5 has not given a notification of determination to perform wireless transmission from the wireless base station device 2 to the wireless terminal device 3 using any dynamic control relay device 4 (NO, in step S301), the subcarrier spacing selection unit 601 also determines normal OFDM subcarrier spacing as the OFDM subcarrier spacing to be used.

For example, if only dynamic control relay devices 4 located at short distances from the wireless base station device 2 are used, there is a low likelihood that the wireless terminal device 3 receives delay waves that exceeds the normal CP length, and thus when the normal OFDM subcarrier spacing is set, this does not cause any problem. On the other hand, if dynamic control relay devices 4 located at distances greater than a predetermined distance from the wireless base station device 2, there is a likelihood that the wireless terminal device 3 receives delay waves that exceeds the normal CP length, and thus OFDM subcarrier spacing narrower than the normal subcarrier spacing is set.

Note that calculation of the distance between the wireless base station device 2 and each of the dynamic control relay devices 4 may be performed such that when the dynamic control relay device 4 is installed, the positional information is registered in the subcarrier spacing selection unit 601, and the distance is calculated based on this positional information and positional information of the wireless base station device 2. Alternatively, by installing a GPS in each dynamic control relay device 4, the GPS information may be acquired as needed by the subcarrier spacing selection unit 601 via a line connecting the dynamic control relay device 4 and the relay device control unit 5, and the distance may be calculated based thereon.

As described above, in the third embodiment, the subcarrier spacing selection unit 601 determines to use the narrowest OFDM subcarrier spacing of OFDM subcarrier spacing corresponding to the distances between the wireless base station device 2 and the dynamic control relay devices 4. That is to say, the subcarrier spacing selection unit 601 determines to use OFDM subcarrier spacing narrower than the normal subcarrier spacing, if the greatest distance of the distances between the wireless base station device 2 and the plurality of dynamic control relay devices 4 is greater than or equal to the predetermined threshold distance X m. By selecting OFDM subcarrier spacing according to the communication path in this manner, it is possible to dynamically switch to a CP length with which the influence of delay waves is reduced (so that the ratio of the CP length to the OFDM symbol length is constant, for example). Accordingly, it is possible to prevent the use of an unduly long CP length and reduce the overhead due to the CP, compared to a case where a CP of a fixed CP length is used taking into consideration delay waves.

### Fourth Embodiment

The wireless communication system 1 according to a fourth embodiment differs from the first embodiment in the OFDM subcarrier spacing determination processing operation performed by the subcarrier spacing selection unit 601 of the wireless base station device 2, and other configurations and operations are the same as those in the first embodiment. Therefore, only the difference from the first embodiment is described, and descriptions of the other features are omitted.

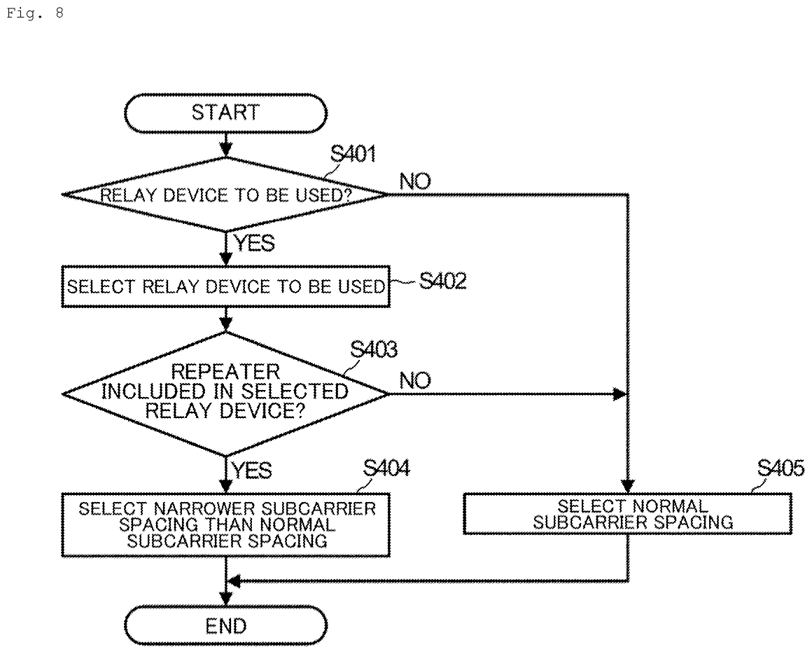

FIG. 8 is a flowchart illustrating an example of an OFDM subcarrier spacing determination processing operation performed by the subcarrier spacing selection unit 601 of the fourth embodiment. The subcarrier spacing selection unit 601 executes the operation as shown in the flowchart to determine OFDM subcarrier spacing for each user, that is, each wireless terminal device 3. If the wireless base station device 2 is constituted by a computer, the processor 201 can execute the processing operation in accordance with this flowchart by executing the communication control program, and can function as the subcarrier spacing selection unit 601.

The subcarrier spacing selection unit 601 determines whether or not the relay device control unit 5 has given a notification of determination to perform wireless transmission from the wireless base station device 2 to the wireless terminal device 3 of a target user using any dynamic control relay device 4 (step S401). The notification given from the relay device control unit 5 may be a notification indicating whether or not any dynamic control relay device 4 is to be used, and information relating to selected one or more dynamic control relay devices 4, that is, information indicating which dynamic control relay device 4 is to be used.

If it is determined that the relay device control unit 5 has given such a notification (YES, in step S401), the subcarrier spacing selection unit 601 selects one or more dynamic control relay devices 4 that are to be used and are included in the notification from the relay device control unit 5 (step S402).

Then, the subcarrier spacing selection unit 601 determines whether or not a repeater is included in the selected dynamic control relay devices 4 (step S402).

Here, if it is determined that a repeater is included (YES, in step S403), the subcarrier spacing selection unit 601 determines, as the OFDM subcarrier spacing to be used, narrower OFDM subcarrier spacing than normally used OFDM subcarrier spacing (step S404).

In contrast, in step S403, if it is determined that no repeater is included (NO, in step S403), the subcarrier spacing selection unit 601 determines the normal OFDM subcarrier spacing as the OFDM subcarrier spacing to be used (step S405). Also, in step S401, if it is determined that the relay device control unit 5 has not given a notification of determination to perform wireless transmission from the wireless base station device 2 to the wireless terminal device 3 using any dynamic control relay device 4 (NO, in step S401), the subcarrier spacing selection unit 601 determines the normal OFDM subcarrier spacing as the OFDM subcarrier spacing to be used.

As described above, in the fourth embodiment, the subcarrier spacing selection unit 601 determines OFDM subcarrier spacing based on the type of dynamic control relay devices 4 to be used. In a repeater, which is an active device, a processing delay due to amplification processing performed within the repeater is added, and thus delays occur more frequently than in a reflector, which is a passive device. Thus, if a repeater is included in the dynamic control relay devices 4 to be used, the subcarrier spacing selection unit 601 determines to use narrower OFDM subcarrier spacing than the normal subcarrier spacing. In this way, when a repeater is used as a dynamic control relay device 4, it is possible to reduce the influence of delay waves resulting from a delay caused by amplification processing within the repeater.

### Fifth Embodiment

The wireless communication system 1 according to a fifth embodiment differs from the first embodiment in the OFDM subcarrier spacing determination processing operation performed by the subcarrier spacing selection unit 601 of the wireless base station device 2, and other configurations and operations are the same as those in the first embodiment. Therefore, only the difference from the first embodiment is described, and descriptions of the other features are omitted.

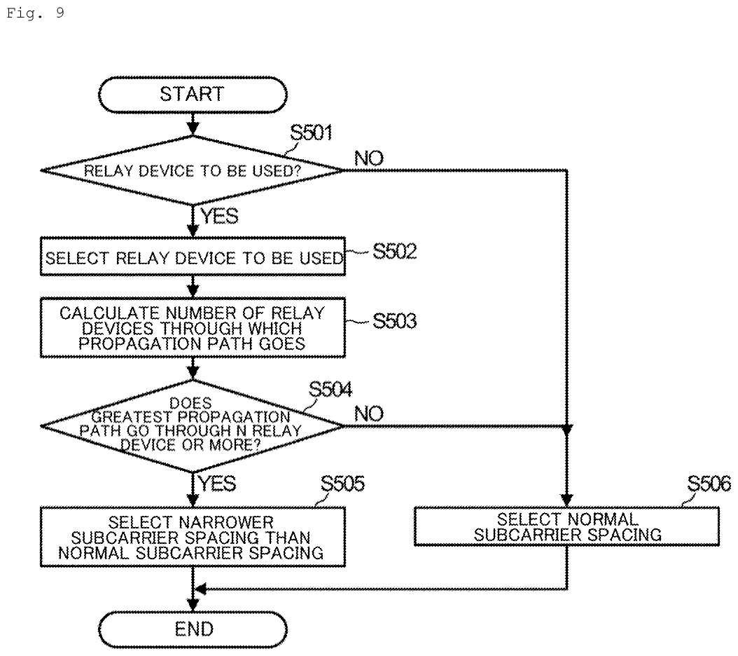

FIG. 9 is a flowchart illustrating an example of an OFDM subcarrier spacing determination processing operation performed by the subcarrier spacing selection unit 601 of the fifth embodiment. The subcarrier spacing selection unit 601 executes the operation as shown in the flowchart to determine OFDM subcarrier spacing for each user, that is, each wireless terminal device 3. If the wireless base station device 2 is constituted by a computer, the processor 201 can execute the processing operation in accordance with this flowchart by executing the communication control program, and can function as the subcarrier spacing selection unit 601.

The subcarrier spacing selection unit 601 determines whether or not the relay device control unit 5 has given a notification of determination to perform wireless transmission from the wireless base station device 2 to the wireless terminal device 3 of a target user using any dynamic control relay device 4 (step S501). The notification given from the relay device control unit 5 may be a notification indicating whether or not any dynamic control relay device 4 is to be used, and information relating to selected one or more dynamic control relay devices 4, that is, information indicating which dynamic control relay device 4 is to be used.

If it is determined that the relay device control unit 5 has given such a notification (YES, in step S501), the subcarrier spacing selection unit 601 selects one or more dynamic control relay devices 4 that are to be used and are included in the notification from the relay device control unit 5 (step S502).

Then, the subcarrier spacing selection unit 601 calculates the number of dynamic control relay devices 4 that are interposed in each propagation path, that is, the number of dynamic control relay devices 4 through which each propagation path goes (step S503). Note here that the subcarrier spacing selection unit 601 may refer to the numbers of dynamic control relay devices that were calculated in advance, instead of calculating the numbers.

Also, the subcarrier spacing selection unit 601 determines whether or not the maximum number of the calculated numbers of dynamic control relay devices 4 is greater than or equal to a predetermined threshold number N, that is, whether or not the propagation path that uses the largest number of dynamic control relay devices 4 goes through at least N dynamic control relay devices 4 (step S504).

Here, if it is determined that the propagation path goes through N (threshold number) dynamic control relay devices 4 or more (YES, in step S504), the subcarrier spacing selection unit 601 determines to use narrower OFDM subcarrier spacing than the normally used OFDM subcarrier spacing (step S505).

In contrast, in step S504, if it is determined that the propagation path that uses the largest number of dynamic control relay devices 4 does not go through at least N dynamic control relay devices 4 (NO, in step S504), the subcarrier spacing selection unit 601 determines the normal OFDM subcarrier spacing as the OFDM subcarrier spacing to be used (step S506). Also, in step S501, if it is determined that the relay device control unit 5 has not given a notification of determination to perform wireless transmission from wireless base station device 2 to the wireless terminal device 3 using any dynamic control relay device 4 (NO, in step S501), the subcarrier spacing selection unit 601 determines the normal OFDM subcarrier spacing as the OFDM subcarrier spacing to be used.

Because a propagation path is longer the larger the number of dynamic control relay devices 4 through which the propagation path goes is, there is a likelihood that delay waves occur in the propagation path. Accordingly, if the number of dynamic control relay devices 4 through which a propagation path goes is a given number or greater, the subcarrier spacing selection unit 601 sets narrower OFDM subcarrier spacing than the normal subcarrier spacing, and otherwise sets the normal OFDM subcarrier spacing.

As described above, in the fifth embodiment, the subcarrier spacing selection unit 601 determines OFDM subcarrier spacing based on the number of dynamic control relay devices 4 to be interposed. That is to say, the subcarrier spacing selection unit 601 estimates respective routes of the plurality of propagation paths that use the selected dynamic control relay devices 4, and if the greatest length of the routes is greater than or equal to a predetermined threshold route length, that is, the number of dynamic control relay devices 4 through which the propagation path goes is greater than or equal to the threshold number N, the subcarrier spacing selection unit 601 determines to use narrower OFDM subcarrier spacing than the normal subcarrier spacing. Thus, it is possible to reduce the influence of delay waves occurring when the dynamic control relay devices 4 are used in the wireless communication system 1.

### Sixth Embodiment

The wireless communication system 1 according to a sixth embodiment differs from the first embodiment in the OFDM subcarrier spacing determination processing operation performed by the subcarrier spacing selection unit 601 of the wireless base station device 2, and other configurations and operations are the same as those in the first embodiment. Therefore, only the difference from the first embodiment is described, and descriptions of the other features are omitted.

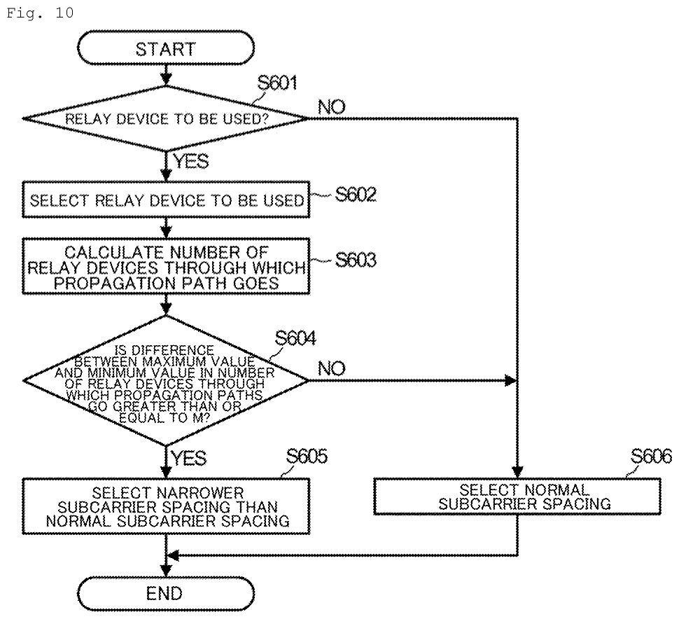

FIG. 10 is a flowchart illustrating an example of an OFDM subcarrier spacing determination processing operation performed by the subcarrier spacing selection unit 601 of the sixth embodiment. The subcarrier spacing selection unit 601 executes the operation as shown in the flowchart to determine OFDM subcarrier spacing for each user, that is, each wireless terminal device 3. If the wireless base station device 2 is constituted by a computer, the processor 201 can execute the processing operation in accordance with this flowchart by executing the communication control program, and can function as the subcarrier spacing selection unit 601.

The subcarrier spacing selection unit 601 determines whether or not the relay device control unit 5 has given a notification of determination to perform wireless transmission from the wireless base station device 2 to the wireless terminal device 3 of a target user using any dynamic control relay device 4 (step S601). The notification given from the relay device control unit 5 may be a notification indicating whether or not any dynamic control relay device 4 is to be used, and information relating to selected one or more dynamic control relay devices 4, that is, information indicating which dynamic control relay device 4 is to be used.

If it is determined that the relay device control unit 5 has given such a notification (YES, in step S601), the subcarrier spacing selection unit 601 selects one or more dynamic control relay devices 4 that are to be used and are included in the notification from the relay device control unit 5 (step S602).

Then, the subcarrier spacing selection unit 601 calculates the number of dynamic control relay devices 4 that are interposed in each propagation path, that is, the number of dynamic control relay devices 4 through which each propagation path goes (step S603). Note here that the subcarrier spacing selection unit 601 may refer to the numbers of dynamic control relay devices that were calculated in advance, instead of calculating the numbers.

Also, the subcarrier spacing selection unit 601 compares the maximum value and the minimum value of the calculated numbers of dynamic control relay devices 4, and determines whether or not a difference thereof is greater than or equal to a predetermined number M (step S604).

Here, if it is determined that a difference between the maximum value and the minimum value of the numbers of dynamic control relay devices 4 through which the respective propagation paths go is greater than or equal to M (YES, in step S604), the subcarrier spacing selection unit 601 determines narrower OFDM subcarrier spacing than the normally used OFDM subcarrier spacing (step S605).

In contrast, in step S604, if it is determined that a difference between the maximum value and the minimum value of the numbers of dynamic control relay devices 4 through which the respective propagation paths go is not greater than or equal to the predetermined threshold number M (NO, in step S604), the subcarrier spacing selection unit 601 determines the normal OFDM subcarrier spacing as the OFDM subcarrier spacing to be used (step S606). Also, in step S601, if it is determined that the relay device control unit 5 has not given a notification of determination to perform wireless transmission from the wireless base station device 2 to the wireless terminal device 3 using any dynamic control relay device 4 (NO, in step S601), the subcarrier spacing selection unit 601 determines the normal OFDM subcarrier spacing as the OFDM subcarrier spacing to be used.

Because a propagation path is longer the larger the number of dynamic control relay devices 4 through which the propagation path goes is, there is a likelihood that delay waves occur in the propagation path. On the other hand, even when the number of dynamic control relay devices 4 through which the propagation path goes is large, there may be a case where no delay wave is received if all of the propagation paths include about the same number of dynamic control relay devices 4. In this case, if OFDM subcarrier spacing is set only based on the number of dynamic control relay devices 4, unnecessary overhead may be caused. Accordingly, if a difference between the maximum value and the minimum value of the numbers of dynamic control relay devices 4 through which the respective propagation paths go is a given number or more, the subcarrier spacing selection unit 601 sets narrower OFDM subcarrier spacing than the normal subcarrier spacing, and otherwise sets the normal OFDM subcarrier spacing.

As described above, in the sixth embodiment, the subcarrier spacing selection unit 601 determines OFDM subcarrier spacing based on a difference between the maximum value and the minimum value of the numbers of dynamic control relay devices 4 through which the respective propagation paths go. That is to say, the subcarrier spacing selection unit 601 estimates respective routes for a plurality of propagation paths that use selected dynamic control relay devices 4, and if a difference between the maximum length and the minimum length of the routes is greater than or equal to a predetermined threshold length, that is, if a difference between the maximum number and the minimum number of dynamic control relay devices 4 through which the propagation paths go is greater than or equal to the threshold number M, the subcarrier spacing selection unit 601 determines to use narrower OFDM subcarrier spacing than the normal subcarrier spacing. Accordingly, it is possible to prevent the use of too much different types of OFDM subcarrier spacing and reduce unnecessary overhead.

### Other Embodiments

At least two of the OFDM subcarrier spacing determination processing operations performed by the subcarrier spacing selection unit 601 that have been described above as the second to sixth embodiments may be used in combination.

Also, the methods described with reference to the embodiments can be stored, as a program (software means) that can cause a computing machinery (computer) to execute it, in a recording medium such as a magnetic disk (such as a floppy (registered trademark) disk or a hard disk), an optical disk (such as CD-ROM, DVD, or MO), or a semiconductor memory (such as a ROM, RAM, or flash memory), or can be transmitted and distributed by a communication medium. Note that the program to be stored in the medium also includes a setting program that configures a software means (including not only an execution program but also a table and a data structure) for causing the computing machinery to execute the program within the computing machinery. The computing machinery that realizes this device reads the program recorded in the recording medium, or configure the software means using the setting program in certain instances, and executes the above-described processing when the software means controls the operations. Note that the recording medium used in the present specification is not limited to being used for distribution, but includes a storage medium such as a magnetic disk or a semiconductor memory that is provided inside the computing machinery or in a device connected via a network.

In short, the present invention is not limited to the above-described embodiments, and in the implementation stage, various modifications are possible without departing from the spirit of the invention. Also, the configurations described in the embodiments above may be implemented in suitable possible combinations, and in such a case, combined effects can be realized. Furthermore, the above-described embodiments include inventions in various stages, and various inventions are extracted through appropriate combinations of a plurality of disclosed constituent elements.

### REFERENCE SIGNS LIST

1 Wireless communication system
2 Wireless base station device
3 Wireless terminal device
4, 4a, 4b, 4c, 4d Dynamic control relay device
5 Relay device control unit
6 Wireless communicator

### 201 Processor

202 Program memory
203 Data memory

### 204 Storage

205 Input/output interface
206 Communication interface
207 Communication unit

### 208 Bus

209 Input unit
210 Display unit

### 211, 313, 613 Antenna

301, 601 Subcarrier spacing selection unit
303, 603 User information selection unit
304, 604 IFFT unit
305, 605 FFT unit
306, 606 CP addition unit
307, 607 CP removal unit

### 308, 608 DAC

### 309, 609 ADC

310, 610 RF antenna unit
311, 312, 611, 612 Signal processing unit
PA1, PA2, PA3, PA4 Propagation path

1. A wireless communication system comprising:
a wireless base station device configured to perform wireless communication of an orthogonal frequency division multiplexing (OFDM) method:
a plurality of dynamic control relay devices for which a reradiation direction of incoming waves is dynamically controllable by the wireless base station device; and
a wireless terminal device configured to perform wireless communication with the wireless base station device using a plurality of propagation paths that go through or do not go through the dynamic control relay devices,
wherein when the wireless communication is performed between the wireless base station device and the wireless terminal device using the plurality of propagation paths that go through the dynamic control relay devices, second OFDM subcarrier spacing is used, the second OFDM subcarrier spacing being spacing that is narrower than first OFDM subcarrier spacing that is used when the wireless communication is performed using the plurality of propagation paths that do not go through the dynamic control relay devices.

2. The wireless communication system according to claim 1,
wherein when the wireless communication is performed using the plurality of propagation paths that go through the dynamic control relay devices, the first OFDM subcarrier spacing is used if a predetermined condition is not satisfied.

3. The wireless communication system according to claim 2,
wherein the wireless base station device selects at least one dynamic control relay device to be used from among the plurality of dynamic control relay devices based on the wireless terminal device,
the predetermined condition is that the selected dynamic control relay device is a relay device for which the second OFDM subcarrier spacing is to be used, and
if the predetermined condition is satisfied, OFDM subcarrier spacing that corresponds to the selected dynamic control relay device is used as the second OFDM subcarrier spacing.

4. The wireless communication system according to claim 2,
wherein the predetermined condition is that the greatest distance of distances between the wireless base station device and the plurality of dynamic control relay devices is greater than or equal to a predetermined threshold distance.

5. The wireless communication system according to claim 2,
wherein the predetermined condition is that an active device is included in the plurality of dynamic control relay devices.

6. The wireless communication system according to claim 2,
wherein the wireless base station device selects dynamic control relay devices to be used, from among the plurality of dynamic control relay devices based on the wireless terminal device, and estimates respective routes of the plurality of propagation paths that go through the plurality of selected dynamic control relay devices, and
the predetermined condition is that the greatest length of the estimated routes is greater than or equal to a predetermined threshold route length, or a difference between the maximum length and the minimum length of the estimated routes is greater than or equal to a predetermined threshold length.

7. A wireless control method that is performed by a wireless communication system that includes: a wireless base station device; and a plurality of dynamic control relay devices for which a reradiation direction of incoming waves is dynamically controllable, the wireless base station device being configured to perform wireless communication of an orthogonal frequency division multiplexing (OFDM) method with a wireless terminal device using a plurality of propagation paths that go through the dynamic control relay devices, the method comprising the steps of:
selecting, by the wireless base station device, dynamic control relay devices to be used in the wireless communication using the plurality of propagation paths, from among the plurality of dynamic control relay devices based on the wireless terminal device with which the wireless communication is to be performed; and
determining, by the wireless base station device, to use second OFDM subcarrier spacing as OFDM subcarrier spacing for use in the wireless communication of the OFDM method, the second OFDM subcarrier spacing being spacing that is narrower than first OFDM subcarrier spacing that is used when the wireless communication is performed using the plurality of propagation paths that do not go through the dynamic control relay devices.

8. A wireless base station device provided in a wireless communication system that includes: the wireless base station device; and a plurality of dynamic control relay devices for which a reradiation direction of incoming waves is dynamically controllable, the wireless base station device being configured to perform wireless communication of an orthogonal frequency division multiplexing (OFDM) method with a wireless terminal device using a plurality of propagation paths that go through the dynamic control relay devices, the wireless base station device comprising:
a relay device control unit configured to select dynamic control relay devices to be used in the wireless communication using the plurality of propagation paths, from among the plurality of dynamic control relay devices based on the wireless terminal device with which the wireless communication is to be performed; and
a subcarrier spacing selection unit configured to determine to use second OFDM subcarrier spacing as OFDM subcarrier spacing for use in the wireless communication of the OFDM method, the second OFDM subcarrier spacing being spacing that is narrower than first OFDM subcarrier spacing that is used when the wireless communication is performed using the plurality of propagation paths that do not go through the dynamic control relay devices.
